(19) United States
(12) Patent Application Publication
(10) Pub. No.: US 2024/0424430 A1
(43) Pub. Date: Dec. 26, 2024

(54) FILTER ASSEMBLY WITH MULTIPLE SEAL ELEMENT

(71) Applicant: Cummins Filtration lnc., Nashville, TN (US)

(72) Inventors: Zemin Jiang, Cookeville, TN (US); Justin Douglass, Mt. Juliet, TN (US); Santosh Bhagwat, Kolhapur (IN); Jack Sims, Columbus, IN (US); Jayant Singh, Pune (IN); Tejasvi Jagdishchandra Lahoti, Pune (IN); Joshua Luther Young, Livingston, TN (US)

(73) Assignee: Cummins Filtration lnc., Nashville, TN (US)

(21) Appl. No.: 18/570,568

(22) PCT Filed: Jun. 23, 2022
(86) PCT No.: PCT/US2022/034654

§ 371 Date: Dec. 14, 2023

(30) Foreign Application Priority Data
Jun. 25, 2021 (IN) 202141028553
Nov. 2, 2021 (IN) 202141050229

(51) Int. Cl. B01D 29/15; B01D 35/00; F01M 11/03; F02M 37/34

(52) U.S. Cl. CPC B01D 29/15; B01D 35/005; B01D 2201/0415; B01D 2201/291; B01D 2201/301; B01D 2201/342; B01D 2201/347; F01M 11/03; F02M 37/34

(57) ABSTRACT

A filter element is provided. The filter element includes a media pack, a first endplate, and a second endplate. The media pack defines a hollow cavity that extends along a center axis. The first endplate is coupled to the media pack and includes a first endplate surface, a first inner flange, a second inner flange, and a first axial sealing member. The first inner flange extends axially away from the first endplate into the hollow cavity of the media pack. The second inner flange defines an L-shaped cross-section and extends radially inward from the first inner flange. The first axial sealing member is positioned within a groove defined by the first inner flange and the second inner flange. The second endplate is coupled to the media pack opposite to the first endplate and includes a second endplate surface, a third inner flange, and a first radial sealing member. The first radial sealing member contacts the third inner flange.

### CROSS-REFERENCE TO RELATED PATENT APPLICATIONS

This PCT Application claims priority to Indian Patent Application No. 202141028553, filed Jun. 25, 2021 and Indian Patent Application No. 202141050229, filed Nov. 2, 2021. The contents of these applications are incorporated herein by reference in their entirety.

### TECHNICAL FIELD

The present application relates generally to liquid filtration systems for internal combustion engine systems.

### BACKGROUND

Internal combustion engine systems require a clean source of fuel to power the engine. Unfiltered fuel may include dirt, metal particles, and other solid contaminants that can damage fuel injectors and other engine components. In order to protect the injectors, many internal combustion engine systems include fuel filtration systems which filter the fuel to remove any solid contaminants before passing the fuel to the injectors. The filtration system may include a filter cartridge and a filter head. In operation, the filtration system directs the fuel through the filter cartridge, which includes a filter element that captures any solid particulate entrained in the fuel. The performance of the filtration system depends, among other factors, on the structure of the filter cartridge and the materials used to construct the filter cartridge (e.g., the materials used to produce a filter element for the filter cartridge, the specifications of the filter element and the media pack such as the flow area of the media pack, the pleat depth of the media pack, and other factors).

Changing of these filters may be a difficult and dirty process. For example, removing the filter may cause fluid to leak onto an operator or components surrounding the internal combustion engine (e.g., frames, electrical components, etc.). Additionally, changing the filter may be a difficult process, requiring the use of specialized tools.

### SUMMARY

At least one embodiment relates to a fluid filtration system. The fluid filtration system includes a filter housing body and a center post coupled to the filter housing body. The filter housing body includes a first housing end and a second housing end opposite the first housing end. Extending from the second housing end are a first passage and a second passage. The center post extends along a central axis of the filter housing body and is in fluid communication with the first passage and the second passage.

Another embodiment relates to a fluid filtration system. The fluid filtration system includes a filter housing body, a center post, and a filter housing lid removably coupled to the filter housing body. The filter housing body is configured to receive a filter element within a housing cavity of the filter housing body. The filter housing body is coupled to an engine interface that includes a first passage and a second passage where both the first passage and the second passage extend away from the filter housing body. The center post is coupled to the filter housing body and extends along a central axis of the filter housing body The center post is in fluid communication with both the first passage and the second passage.

Another embodiment relates to a fluid filtration system. The fluid filtration system includes a filter element. The filter element includes a media pack, a first endplate, and a second endplate. The media pack defines a hollow cavity that extends along a center axis. The first endplate is coupled to the media pack and includes a first endplate surface, a first inner flange, a second inner flange, and a first axial sealing member. The first inner flange extends axially away from the first endplate into the hollow cavity of the media pack. The second inner flange defines an L-shaped cross-section and extends radially inward from the first inner flange. The first axial sealing member is positioned within a groove defined by the first inner flange and the second inner flange. The first axial sealing member is configured to compress against an axial center post of a fluid filtration system to form a first sealing engagement. The second endplate is coupled to the media pack opposite to the first endplate and includes a second endplate surface, a third inner flange, and a first radial sealing member. The third inner flange extends axially away from the second endplate surface and towards the first endplate. The first radial sealing member contacts the third inner flange.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a cross-sectional view of a fluid filtration system with a filter element and a filter housing lid installed, according to an example embodiment;

FIG. 2 is a cross-sectional view of the fluid filtration system of FIG. 1 with the filter element and the filter housing lid removed;

FIG. 3 is a cross-sectional view of the fluid filtration system of FIG. 1 with the filter housing lid installed and with the filter element removed;

FIG. 4 is a cross-sectional view of the filter element of the fluid filtration system of FIG. 1;

FIG. 5 is a detailed cross-sectional view of the fluid filtration system of FIG. 1 at view window AA;

FIG. 6 is a detailed cross-sectional view of the filtration system of FIG. 1 at view window BB with the filter element of FIG. 1 having a second end plate, according to an example embodiment;

FIG. 7 is a front view of a fluid filtration system and an engine interface, according to an example embodiment;

FIG. 8 is a side view of the fluid filtration system and engine interface of FIG. 7;

FIG. 9 is a rear view of the fluid filtration system and engine interface of FIG. 7;

FIG. 10 is a cross-sectional view of the fluid filtration system of FIG. 7;

FIG. 11 is a cross-sectional view of a filter element for use in the fluid filtration system of FIGS. 1-3 and 7-10;

FIG. 12 is a cross-sectional view of an axial center post for use the fluid filtration system of FIGS. 1-3 and 7-10 10;

FIG. 13 is a top perspective view of an outer portion of the axial center post of FIG. 12;

FIG. 14 is a bottom perspective view of the outer portion of the axial center post of FIG. 12;

FIG. 15 is a perspective view of an inner portion of the axial center post of FIG. 12;

FIG. 16 is a cross-sectional view of the fluid filtration system of FIG. 10, showing a fluid flow path;

FIG. 17 is a detailed cross-sectional view of the fluid filtration system of FIG. 10, showing a fluid flow path; and

FIG. 18 is a rear view of the fluid filtration system and engine interface of FIG. 9, showing a fluid flow path;

It will be recognized that some or all of the Figures are schematic representations for purposes of illustration. The Figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for filtering a fluid that flows through a fluid filtration system. As used herein, “fluid” can refer to air, oil, fuel, etc. or any other gas or liquid that could be subject to filtration in accordance with the concepts described herein. The various concepts introduced above and discussed in greater detail below may be implemented in any of numerous ways, as the described concepts are not limited to any particular manner of implementation. Examples of specific implementations and applications are provided primarily for illustrative purposes.

In various cartridge type top load filter assembly designs, while installing the filter element, the bottom end plate may create an internal seal. During servicing, it is desirable to have clean servicing and self-draining. More particularly, it is desirable for an operator to be able to remove the filter element without spilling the fluid being filtered (e.g., fuel, oil, etc.) out of the fluid filtration system. Additionally, it is desirable for a filter element to drain itself while it is being removed or once it is removed such that the fluid contained in the filter element is drained from the vicinity without any additional operation.

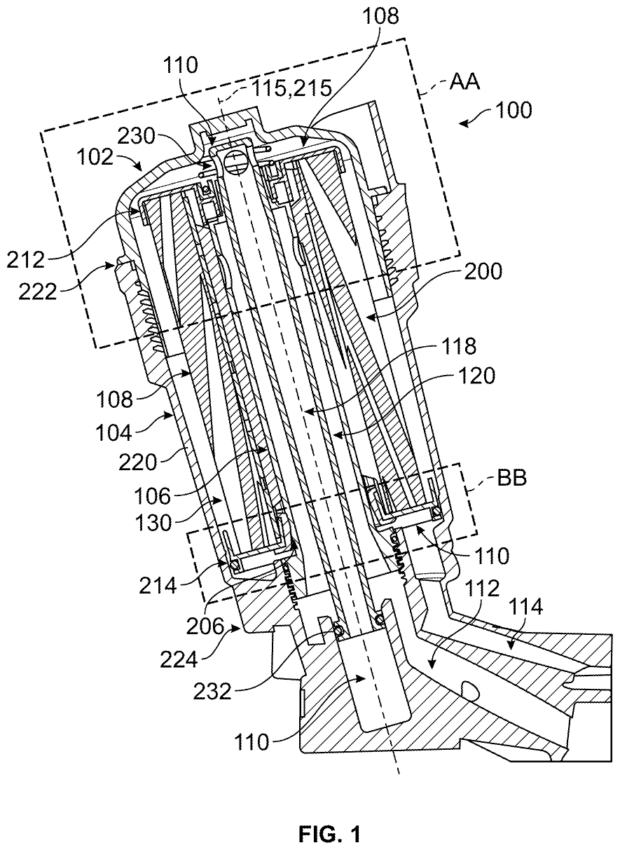

FIG. 1 is a cross-sectional view of an example liquid filtration system, shown as a system 100. The system 100 may be used to filter a fluid provided to an internal combustion engine. The fluid may be a fuel, an engine oil, a hydraulic oil, or another lubricant. In the example embodiment of FIG. 1, the system 100 is a fuel filtration system for an engine that uses fuel to drive the combustion process. In some embodiments, the system 100 is configured to be mounted on the engine (for example a diesel engine). In some embodiments, the system 100 is configured for mounting remotely from the engine (e.g., on a vehicle chassis, etc.).

The system 100 includes a filter housing lid 102, a filter housing body 104, an axial center post 106, and a filter element 108. The filter housing lid 102 is removably coupled with the filter housing body 104. In some embodiments, the filter housing lid 102 is threadingly engaged with the filter housing body 104. In some embodiments, a seal member is operatively positioned between the filter housing body 104 and the filter housing lid 102 such that a sealing engagement is formed between the filter housing body 104 and the filter housing lid 102.

The filter element 108 is disposed within a hollow cavity 130 of the filter housing body 104 such that a center axis 115 of the filter housing body 104 extends through the filter element 108. The filter element 108 may be cylindrically-shaped and may include a cylindrically-shaped media pack 200. The media pack 200 includes filter media configured to filter particulate matter from a fluid flowing therethrough so as to produce filtered fluid (e.g., clean fluid). The filter media may include a porous material having a predetermined pore size. The filter media may include a paper-based filter media, a fiber-based filter media, a foam-based filter media, or the like. The filter media may be pleated or formed into another desired shape to increase a flow area through the media pack 200, or to otherwise alter the particle removal efficiency of the filter element 108. The filter element 108 may be arranged as an outside-in flow filter element having an outer dirty side and an inner clean side. In an alternative arrangement, the filter element 108 is an inside-out filter element having an inner dirty side and an outer clean side. Fluid to be filtered passes from the dirty side of the filter element 108 to the clean side of the filter element 108.

The filter element 108 defines a central opening 206 extending along a center axis 215 (e.g., a longitudinal axis, up and down as shown in FIG. 1) of the filter element 108. In some embodiments, the filter element 108 is positioned within the filter housing body 104 such that the center axis 215 of the filter element 108 is coaxial (e.g., coincident) with the center axis 115 of the filter housing body 104. In some embodiments, a center support tube is positioned within the media pack 200 and extends longitudinally along at least a portion of the central opening 206 from a first, upper end 212 of the filter element 108 to a second, bottom end 214 of the filter element 108. The media pack 200, and thus the support tube, is concentric with the filter element 108 and the filter housing body 104. In other words, a center axis of the media pack 200 is coaxial or substantially coaxial with the center axis 215 of the filter element 108 as a whole and the center axis 115 of the filter housing body 104.

The filter housing body 104 defines a sidewall 220 having an inner cross-sectional diameter within which the filter element 108 is positioned. The filter housing body 104 (e.g., a filter housing, container, or reservoir) includes a first (e.g., first housing, upper, open) end 222, a second (e.g., second housing, lower) end 224, and the sidewall 220 extending between the first end 222 and the second end 224 in a substantially concentric orientation relative to the center axis 115. The filter housing body 104 may be formed from a strong and rigid material. For example, the filter housing body 104 may be formed from a plastic material (e.g., polypropylene, high density polyethylene, polyvinyl chloride, nylon, etc.), a metal (e.g., aluminum, stainless steel, etc.), or another suitable material. The cross-sectional shape of the filter housing body 104 may be the same or similar to the cross-sectional shape of the filter element 108. In some embodiments, the filter housing body 104 is formed in the shape of a cylinder such that the filter housing body 104 has a generally circular cross-section normal to the center axis 115 of the filter housing body 104. In some embodiments, the filter housing body 104 has any other suitable cross-sectional shape. For example, a cross-section of the filter housing body 104 may define a racetrack/obround, oval, rounded rectangular, or another suitable shape.

Extending from the second end 224 of the filter housing body 104 are a plurality of passages (e.g., flow paths, conduits, etc.), shown as a first passage 110, a second passage 112, and a third passage 114. The plurality of passages may be formed with the filter housing body 104 such that the plurality of passages and the filter housing body 104 are formed of a single body. For example, the plurality of passages may be formed together, such as by casting, machining, and the like, such that the filter housing body 104 and the plurality of passages are integrally formed with each other. The first passage 110 may be an inlet passage configured to receive a flow of fluid and provide the flow of fluid to the axial center post 106. The second passage 112 may be an outlet passage configured to receive a flow of fluid from the axial center post 106 and provide the flow of fluid to a downstream system, such as an engine. The third passage 114 may be a drain passage configure to receive a fluid from the hollow cavity 130 of the filter housing body 104 and provide the fluid to a downstream reservoir, such as a fuel tank. In some embodiments, the third passage 114 provide the fluid to a reservoir that is positioned upstream of one of the first passage 110 and the second passage 112. For example, in embodiments where the filter element 108 is an outside-to-inside filter element, and the first passage 110 provides a pre-filtered flow of fluid to the hollow cavity of the filter housing body 104, the third passage 114 may provide a flow of either pre-filtered fluid or post-filtered fluid to a reservoir upstream of the first passage 110, such as when a used filter element, saturated with fluid, is removed and replaced. The fluid flows through the third passage 114 and to a reservoir upstream of the first passage 110 to be filtered or re-filtered when the filter element 108 is replaced. In some embodiments, the filter housing body 104 does not include the third passage 114.

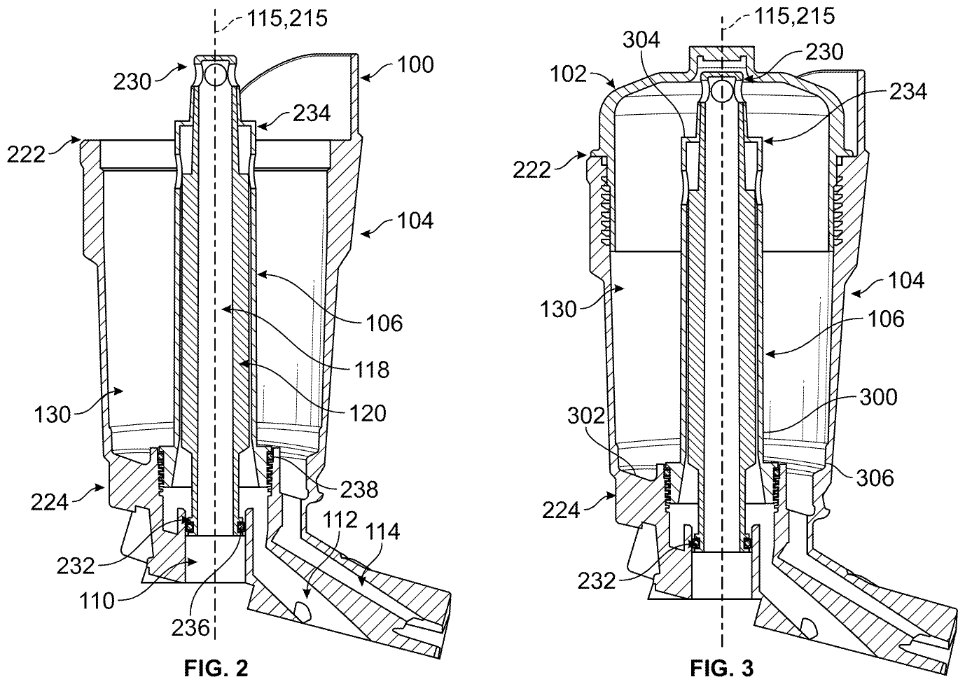

Referring now to FIG. 2, a portion of the system 100 is shown, with the filter housing lid 102 and the filter element 108 removed for clarity. The axial center post 106 is coupled with the filter housing body 104 and extends along a center axis 115 of the filter housing body 104. The axial center post 106 includes a first post end 230 and a second post end 232. In some embodiments, the first post end 230 extends out of the filter housing body 104 and beyond the first end 222. The second post end 232 is coupled with the filter housing body 104 proximate to the second end 224. The second post end 232 extends into first passage 110 such that the first passage 110 is in fluid communication with a first post passage 118. The first post passage 118 extends axially along the center axis 115 from the first post end 230 to the second post end 232. The axial center post 106 is coupled with the filter housing body 104 such that the second post passage 120 is fluidly coupled with the second passage 112. The second post passage 120 is concentric about both the first post passage 118 and the center axis 115. The first post passage 118 and the second post passage 120 are fluidly isolated from one another.

A post shoulder 234 (e.g., flange, step, etc.) extends radially away from the axial center post 106 proximate to the first post end 230. In some embodiments, as shown in FIG. 2, the post shoulder 234 is positioned between the first post end 230 and the first end 222. In other words, the first end 222 defines a plane, and the post shoulder 234 is positioned between the first post end 230 and the plane defined by the first end 222. The post

The axial center post 106 further includes a first post sealing member 236 coupled to the second post end 232 and configured to fluidly isolate the first passage 110 from the second passage 112 when the center post 106 is coupled to the filter housing body 104. The first post sealing member 236 forms a sealing engagement between the center post 106 and the filter housing body 104 to fluidly couple the first passage 110 to the first post passage 118. The axial center post 106 further includes a second post sealing member 238 coupled proximate to the second post end 232. A circumference of the second post sealing member 238 is greater than a circumference of the first post sealing member 236. The second post sealing member 238 is configured to fluidly isolate the hollow cavity 130 of the filter housing body 104 from the second passage 112. The first post sealing member 236 and the second post sealing member 238 cooperate to fluidly couple the second passage 112 to the second post passage 120.

Referring now to FIG. 3, the system 100 is shown with the filter housing lid 102 coupled with the filter housing body 104, and with the filter element 108 removed for clarity. The system 100 includes a plurality of sealing surfaces configured to provide a sealing engagement with a plurality of portions of the filter element 108.

A first sealing surface 300 is defined by the axial center post 106. The first sealing surface 300 is disposed within the hollow cavity 130 and is positioned proximate to the second post end 232. In other words, the first sealing surface 300 is positioned within the hollow cavity 130 above a lower internal catch 302 of the filter housing body 104. The first sealing surface 300 is substantially cylindrical in shape. In some embodiments, the first sealing surface 300 is slightly tapered and defines a frustoconical profile. The first sealing surface 300 may be integrally formed with the axial center post 106, such as by a machining process, lathing process, and the like. In some embodiments, the first sealing surface 300 is formed from a material different from the axial center post 106, such as an overmolded plastic, rubber, or ceramic material. The first sealing surface 300 is configured to provide a radial sealing engagement with a sealing member of the filter element 108 when the filter element 108 is installed within the hollow cavity 130 of the filter housing body 104.

A second sealing surface 304 is defined by the post shoulder 234. The second sealing surface 304 is a substantially circular or hoop-shaped surface configured to provide an axial sealing engagement with the filter element 108 when the filter element 108 is installed within the hollow cavity 130 of the filter housing body 104. In some embodiments, the second sealing surface 304 lies on a plane that is perpendicular to the center axis 115. In some embodiments, the second sealing surface 304 defines a frustoconical profile that tapers toward a smaller diameter as the second sealing surface 304 extends toward the first post end 230. The second sealing surface 304 may be integrally formed with the axial center post 106, such as by a machining process, lathing process, and the like. In some embodiments, the second sealing surface 304 is formed from a material different from the axial center post 106, such as an overmolded plastic, rubber, or ceramic material.

A third sealing surface is defined by an annular inner surface of the filter housing body 104 proximate to the lower internal catch 302. In some embodiments, the third sealing surface 306 is contiguous with the lower internal catch 302. The third sealing surface 306 is configured to provide a radial sealing engagement with the filter element 108 when the filter element 108 is installed within the hollow cavity 130 of the filter housing body 104. In some embodiments, such as when the filter housing body 104 does not include the third passage 114, the third sealing surface 306 may be optional.

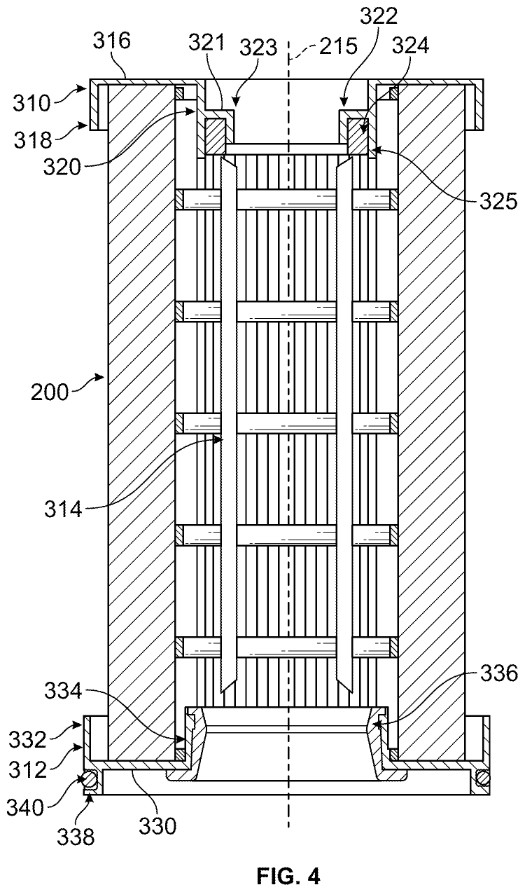

Referring now to FIG. 4, a cross-sectional view of the filter element 108 is shown, according to an example embodiment. The filter element 108 includes a first endplate 310, a second endplate 312, and the media pack 200 extending between the first endplate 310 and the second endplate 312. Extending axially along an interior of the media pack 200 is a media support structure 314. The media support structure 314 may be coupled with both the first endplate 310 and the second endplate 312 and may provide rigidity to the media pack 200.

The first endplate 310 is an open endplate and includes an annular first endplate surface 316, a first outer flange 318, and a first inner flange 320. The first outer flange 318 and the first inner flange 320 extend axially away from the first endplate surface 316 and toward the second endplate 312. The first inner flange 320 extends into the hollow cavity 130 of the media pack 200. Extending radially inwardly from the first inner flange 320 is a second inner flange 322. The second inner flange 322 has an L-shape and is configured for coupling with a first element sealing member 324. The first inner flange 320 and the second inner flange 322 cooperate to define a substantially annular sealing channel 325 configured to receive the first element sealing member 324. The first element sealing member 324 may define a rectangular cross-section and may form a friction fit with the sealing channel 325. In some embodiments, the first element sealing member 324 may comprise an O-ring, a gasket, and the like. The first element sealing member 324 may be bonded with the first endplate 310, such as by using adhesives or by overmolding. In some embodiments, the first element sealing member 324 is removable from the first endplate 310 so that the first element sealing member 324 can be replaced. The first element sealing member 324 is configured for sealingly engaging the second sealing surface 304 and forming an axial seal with the axial center post 106. The first element sealing member 324 is positioned entirely within the media pack 200. Specifically, the first element sealing member 324 has a diameter less than the diameter of the first endplate surface 316 and less than the first inner flange 320. In some embodiments, the first inner flange 320, the second inner flange 322, and the first element sealing member 324 cooperate such that an “inner” axial seal is formed with the post shoulder 234 of the axial center post 106. Specifically, the first inner flange 320 extends further from the first endplate surface 316 than does the second inner flange 322. When the first element sealing member 324 is compressed against the post shoulder 234, the first element sealing member 324 may squeeze inwardly toward the center axis 115. In some embodiments, the second inner flange 322 may extend further from the first endplate surface 316 than the first inner flange 320 to form an “outer” axial seal with the axial center post 106. In such embodiments, when the first element sealing member 324 is compressed against the post shoulder 234, the first element sealing member 324 may squeeze outwardly away from the center axis 115.

The second inner flange 322 further includes a second flange surface 321 positioned radially within the first endplate surface 316 and positioned between the first endplate surface 316 and the second endplate surface 330 and is positioned entirely within the hollow cavity of the media pack 200. The second flange surface 321 cooperates with an inner surface of the first inner flange 320 to define a biasing groove 323 configured to receive a portion of a biasing member.

The second endplate 312 is an open endplate and includes an annular second endplate surface 330, a second outer flange 332, and a third inner flange 334. In some embodiments, the second endplate 312 defines a diameter greater than a diameter of the first endplate 310. The second outer flange 332 and the third inner flange 334 extend axially away from the second endplate surface 330 and toward the first endplate 310. The third inner flange 334 extends into the hollow cavity 130 of the media pack 200. Coupled with the third inner flange 334 is a second element sealing member 336. The second element sealing member 336 is a radial seal configured to form a radial sealing engagement with the first sealing surface 300 of the axial center post 106. In some embodiments, the second element sealing member 336 may comprise a snap-on radial seal member that includes a groove configured to receive a portion of the third inner flange 334. In some embodiments, the second element sealing member 336 is bonded with the second endplate 312, such as by using adhesives or by overmolding. In some embodiments, the second element sealing member 336 is removable from the second endplate 312 so that the second element sealing member 336 can be replaced. The first element sealing member 324 and the second element sealing member 336 cooperate to seal the dirty side from the clean side. In some embodiments, the second element sealing member 336 defines a frustoconical profile that tapers to a smaller diameter as the second element sealing member 336 extends into the filter element 108.

Extending axially away from the second endplate surface 330 in a direction opposite to the media pack 200 is a third outer flange 338. The third outer flange 338 extends axially away from the second endplate surface 330 in a direction away from the first endplate 310. In some embodiments, the third outer flange 338 defines a diameter greater than a diameter of the media pack 200. The third outer flange 338 defines an L-shaped cross-sectional profile that defines a groove and is configured to receive a third element sealing member 340. The third element sealing member 340 is a radial seal and is configured to sealingly engage the third sealing surface 306 of the filter housing body 104. The third element sealing member 340 may be an O-ring, gasket, and the like. In some embodiments, the third element sealing member 340 is bonded with the second endplate 312, such as by using adhesives or by overmolding. In some embodiments, the third element sealing member 340 is removable from the second endplate 312 so that the third element sealing member 340 can be replaced. In some embodiments, the second outer flange 332 includes a groove configured for coupling with the third element sealing member 340 such that the third element sealing member 340 is positioned between the first endplate surface 316 and the second endplate surface 330. In some embodiments, the filter element 108 does not include the third outer flange 338 or the third element sealing member 340. For example, when the filter housing body 104 does not include the third passage 114, the third element sealing member 340 may not be necessary for operation.

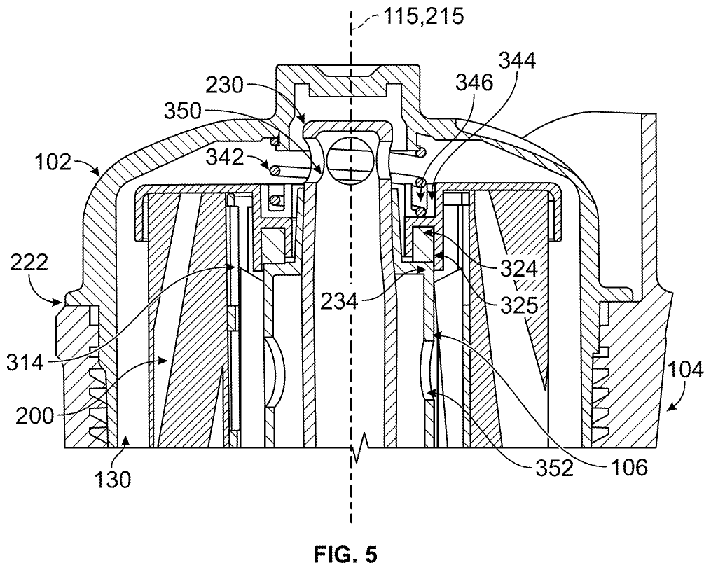

Referring now to FIG. 5, a detailed view of the system 100 is shown in window AA of FIG. 1. The filter element 108 is shown positioned within the filter housing body 104 such that the center axis 215 is co-linear with the center axis 115 and the axial center post 106 extends through the filter element 108. The filter housing lid 102 is shown coupled with the filter housing body 104. Positioned between the first endplate 310 and the filter housing lid 102 is a biasing member 342. The biasing member provides a compressive force to the filter element 108 to compress the first element sealing member 324 against the post shoulder 234. The biasing member 342 is centered on the center axis 115 and surrounds the first post end 230.

The biasing member 342 applies a force to the first endplate 310. Specifically, the biasing member 342 provides a force to the second inner flange 322 opposite to the first element sealing member 324. A biasing ring 344 may be provided between the biasing member 342 and the second inner flange 322 to facilitate positioning of the biasing member 342 relative to the first endplate 310. The biasing ring 344 includes a ring channel 346 configured to receive the biasing member 342.

A first post aperture 350 is positioned at the first post end 230 and is in fluid communication with the first post passage 118, the first passage 110, and the hollow cavity 130 of the filter housing body 104. The first post aperture 350 is configured to receive a flow of fluid from the first post passage 118. The first post passage 118 is configured to receive the flow of fluid from the first passage 110. When the flow of fluid exits the first post aperture 350, a fluid pressure is realized between the filter housing lid 102 and the filter element 108. The fluid pressure exerts a force against the first endplate 310, which cooperates with the biasing member 342 to compress the first element sealing member 324 against the post shoulder 234 such that a sealing engagement is formed between the first endplate 310 and the axial center post 106.

In embodiments where the filter element 108 is an outside-to-inside filter element, the first post passage 118 provides a flow a pre-filtered fluid to a “dirty” side of the filter element 108 via the first post aperture 350. The pre-filtered fluid then flows radially inward through the media pack 200 to a “clean” side (e.g., internal volume) of the filter element 108. The filtered fuel flows into a second post aperture 352 of the center post 106, the second post aperture 352 being in fluid communication with the second post passage 120 and with the second passage 112. The second post aperture 352 is positioned between the first post end 230 and the second post end 232. In some embodiments, the second post aperture 352 is positioned at a location between the post shoulder 234 and the second post sealing member 238. As shown in FIG. 5, the second post aperture 352 is located at a position nearer to the first post end 230 than to the second post end 232. The filtered fuel flows to the second passage 112 via the second post aperture 352 and the second post passage 120. Accordingly, the post shoulder 234 is positioned between the first post aperture 350 and the second post aperture 352.

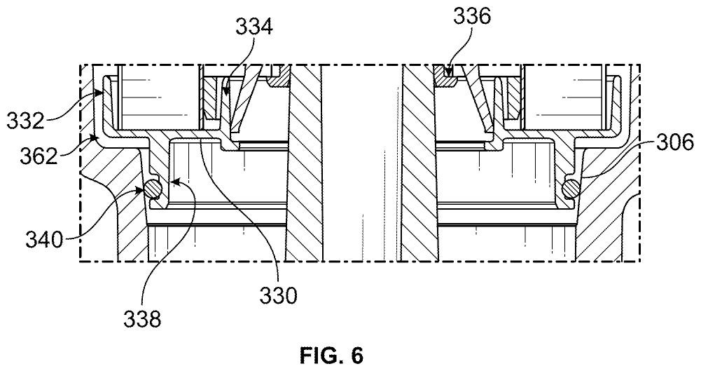

Referring now to FIG. 6, a detailed cross-sectional view of the filter element 108 is shown having a second endplate 362, according to an example embodiment. The second endplate 362 is similar to the second endplate 312 shown in FIGS. 1 and 4. A difference between the second endplate 362 and the second endplate 312 is that the third outer flange 338 extends axially from the second endplate surface 330 at a position approximately half way between the second outer flange 332 and the third inner flange 334. The third outer flange 338 includes a groove structured to receive the third element sealing member 340, the third element sealing member 340 configured to form a sealing engagement with the third sealing surface 306 to fluidly isolate the third passage 114 from the hollow cavity of the filter housing body 104.

The third sealing surface 306 is shown sloped inward toward the second end 224 of the filter housing body 104. The third sealing surface 306 includes a frustoconical profile that tapers inward to provide a secure seal between the second endplate 312, 362 and the filter housing body 104 when the filter housing lid 102 is coupled to the filter housing body 104. When the filter element 108 is positioned within the filter housing body 104 and the filter housing lid 102 is coupled to the filter housing body 104, the biasing member 342 applies an axial force to the filter element 108 in the direction of the second housing end 224. The axial force wedges the third outer flange 338 into the frustoconical third sealing surface 306 to form a sealing engagement between the third element sealing member 340 and the third sealing surface 306.

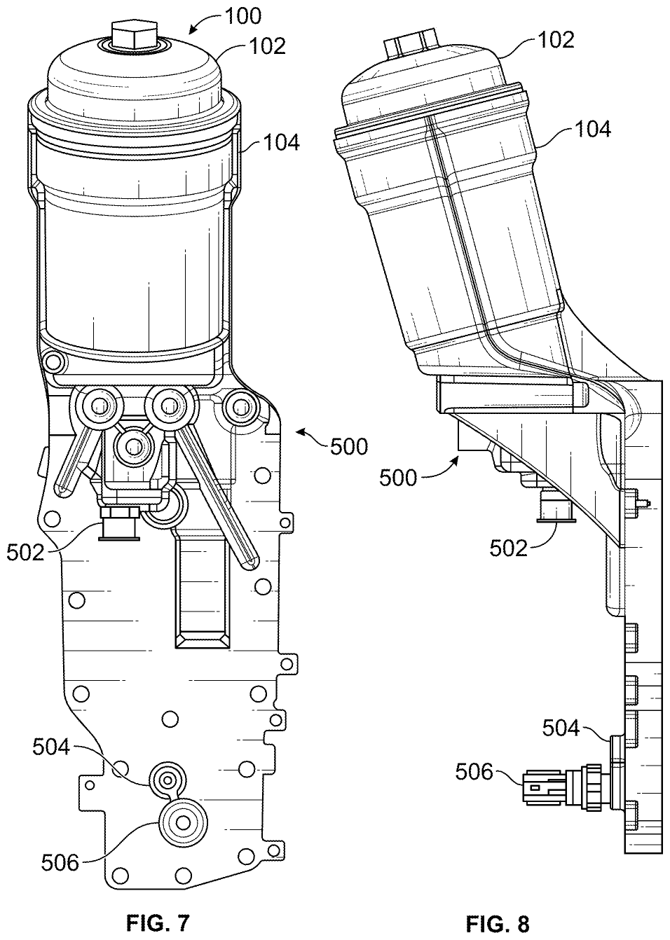

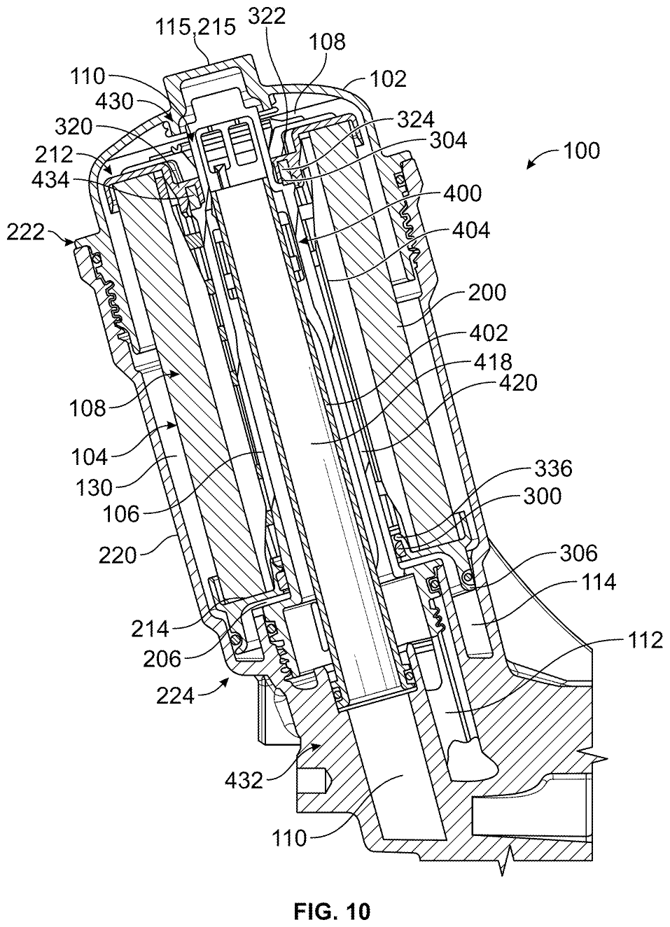

Referring generally to FIGS. 7-9, various views of the fluid filtration system 100 coupled to an engine interface 500 are shown, according to an example embodiment. The fluid filtration system 100 and engine interface 500 may be used in any of the embodiments described herein, such as the embodiment shown in FIG. 1 and/or the embodiment shown in FIG. 10.

Referring to FIGS. 7 and 8, a front view and a side view of the fluid filtration system 100 and the engine interface 500 are shown. As described herein, the fluid filtration system 100 includes the filter housing lid 102 and a filter housing body 104. As briefly described above, the fluid filtration system 100 may be coupled to a downstream component such as the engine interface 500. The engine interface 500 is fluidly coupled to the fluid filtration system 100 and provides fluid to and receives fluid from the fluid filtration system 100.

The engine interface 500 includes a turbo fitting 502, a diagnostic port 504, and a pressure sensor 506. The turbo fitting 502 is a fluid port structured to provide fluid to and/or receive fluid from a downstream device such as an engine. The diagnostic port 504 is structured to receive and/or communicatively couple to a diagnostic device such as an engine sensor, an engine control module, and the like such that the diagnostic device may detect one or more operational parameters associated with the fluid filtration system 100 and/or the engine interface 500. The pressure sensor 506 is structured to detect a pressure of a fluid in the engine interface 500. For example, the pressure sensor 506 is structured to detect a pressure of an inlet fluid (e.g., fluid provided to the fluid filtration system 100 at the first passage 110), an outlet fluid (e.g., fluid received from the fluid filtration system 100 at the second passage 112), or a drain fluid (e.g., fluid received from the fluid filtration system 100 at the third passage 114). The pressure sensor 506 is communicatively coupled to the diagnostic port 504 such that the detected pressure is communicated to a diagnostic device.

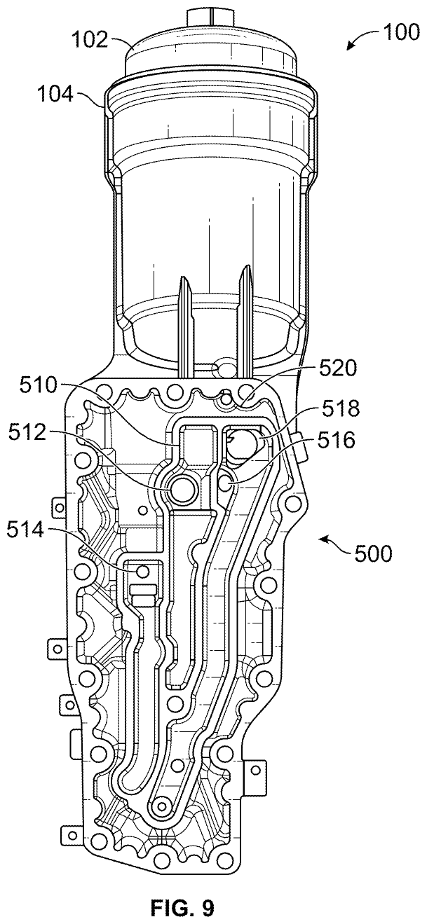

FIG. 9 is a rear view of the fluid filtration system 100 and engine interface 500 of FIG. 7. The engine interface 500 includes an inlet port 510, a bypass valve 512, a pressure regulator valve 514, a cross drill 516, an outlet port 518, and a drain port 520. The inlet port 510 is fluidly coupled to the first passage 110. The pressure regulator valve 514 is structured to regulate a pressure of the fluid before flowing through the inlet port 510. The pressure regulator valve 514 is operated by a feedback control from the pressure sensor 506. The outlet port 518 is fluidly coupled to the second passage 112 of the fluid filtration system 100 such that the engine interface 500 receives a filtered fluid from the fluid filtration system 100. The drain port 520 is fluidly coupled to the third passage 114 of the fluid filtration system 100 such that the engine interface receives a drained fluid from the fluid filtration system 100.

FIG. 10 is a cross-sectional view of the fluid filtration system 100, according to an additional example embodiment. The system 100 includes a filter housing lid 102, a filter housing body 104, and a filter element 108 that are substantially similar to or the same as the corresponding components described herein above. The axial center post 400 is substantially similar in function to the axial center post 106. For example, the axial center post 40b0 is coupled with the filter housing body 104 and extends along the center axis 115 of the filter housing body 104. The axial center post 400 includes a first post end 430 and a second post end 432. In some embodiments, the first post end 430 extends out of the filter housing body 104 and beyond the first end 222. The second post end 432 is coupled with the filter housing body 104 proximate to the second end 224.

The axial center post 400 includes an inner post 402 and an outer post 404. The inner post 402 is substantially hollow and defines a first post passage 418. The second post end 432 extends into first passage 110 such that the first passage 110 is in fluid communication with a first post passage 418 such that the first passage 110 provides the flow of fluid to the axial center post 400. A space between the inner post 402 and the outer post 404 defines a second post passage (e.g., outer post passage) 420. The axial center post 400 is coupled with the filter housing body 104 such that the second post passage 420 is fluidly coupled with the second passage 112. The first post passage 418 and the second post passage 420 are fluidly isolated from one another. The second passage 112 is an outlet passage configured to receive a flow of fluid from the axial center post 400 and provide the flow of fluid to a downstream system.

The outer post 404 includes a post shoulder 434 (e.g., flange, step, etc.) that extends radially away from the axial center post 400 proximate to the first post end 430. In some embodiments, as shown in FIG. 5, the post shoulder 434 is positioned between the first post end 430 and the first end 222. In other words, the first end 222 defines a plane, and the post shoulder 434 is positioned between the first post end 430 and the plane defined by the first end 222.

According to an example embodiment, the axial center post 400 defines the first sealing surface 300 and the second sealing surface 304 substantially similarly to the axial center post 106. For example, the first sealing surface 300 is defined by the axial center post 400 proximate to the second post end 432. In some embodiments, the first sealing surface 300 is formed from a material different from the axial center post 400, such as an overmolded plastic, rubber, or ceramic material. As described above, the first sealing surface 300 is configured to provide a radial sealing engagement with the second element sealing member 336 when the filter element 108 is installed within the hollow cavity 130 of the filter housing body 104. The second sealing surface 304 is defined by the post shoulder 434. The second sealing surface 304 may be integrally formed with the axial center post 400, such as by a machining process, lathing process, and the like. In some embodiments, the second sealing surface 304 is formed from a material different from the axial center post 400, such as an overmolded plastic, rubber, or ceramic material. Accordingly, the first element sealing member 324 is configured for sealingly engaging the second sealing surface 304 and forming an axial seal with the axial center post 400 similarly to the axial center post 106. In some embodiments, the first inner flange 320, the second inner flange 322, and the first element sealing member 324 cooperate such that an “inner” axial seal is formed with the post shoulder 234 of the axial center post 400. When the first element sealing member 324 is compressed against the post shoulder 434, the first element sealing member 324 may squeeze inwardly toward the center axis 115.

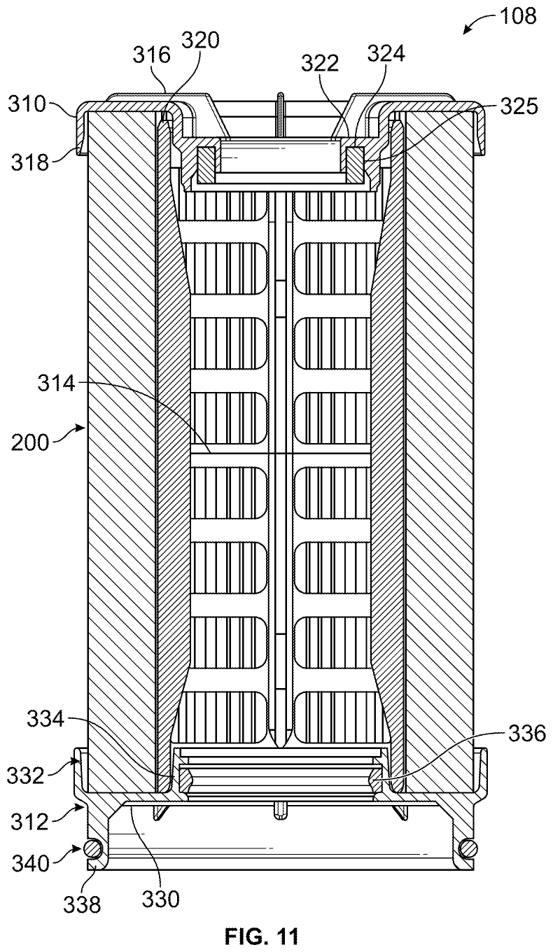

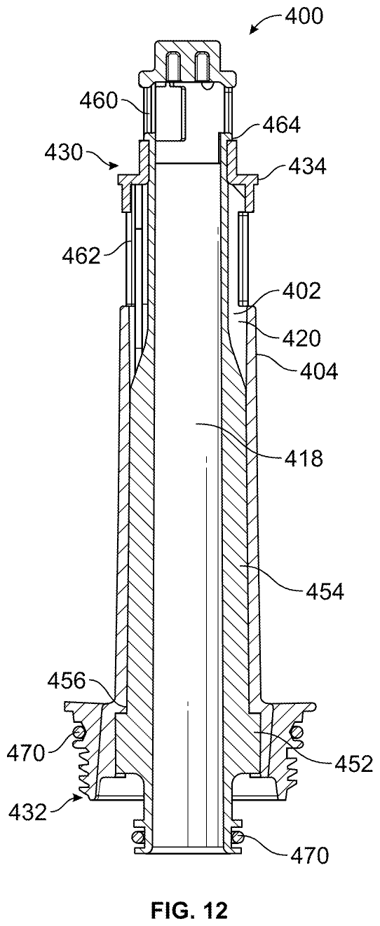

FIG. 11 is a cross-sectional view of the filter element 108 of FIG. 4. The cross section shown in FIG. 11 shows the first element sealing member 324, the second element sealing member 336, and the third element sealing member 340. The first element sealing member 324 is an irregular gasket. As described above, the first element sealing member 324 defines a rectangular cross-section and forms a friction fit with the sealing channel 325. The second element sealing member 336 is an irregular gasket formed to fit between the third inner flange 334 of the second endplate 312 and the axial center post 106, 400. As described above, the third element sealing member 340 is a radial seal and is configured to sealingly engage the third sealing surface 306 (shown in FIG. 10) of the filter housing body 104.

FIG. 12 is a cross-sectional view of an axial center post for the fluid filtration system of FIG. 10. As briefly described above, the axial center post 400 includes an inner post 402 and an outer post 404. The inner post 402 includes one or more tabs 452 and one or more ribs 454. The one or more ribs 454 extend at least partially between the first post end 430 and the second post end 432. In some embodiments, at least one of the one or ribs 454 is coupled to at least one of the one or more tabs 452. The one or more ribs 454 are structured to space the inner post 402 away from the outer post 404 such that the second post passage 420 is defined in the space between the inner post 402 and the outer post 404 (e.g., the space between the one or more ribs 454). The one or more tabs 452 are disposed at the second post end 432.

The outer post 404 includes a first set of windows 460 disposed at the first post end 430 and a second set of windows 462 disposed between the first set of windows 460 and the second post end 432. The first set of windows 460 define an outlet for the first post passage 418 such that the first post passage 418 is in fluid communication with the media pack 200. The second set of windows 462 define an inlet of the second post passage 420 such that the second post passage 420 receives the filtered fluid from the media pack 200. The outer post 404 also includes one or more slots 456 disposed at the second post end 432. The one or more slots 456 are each configured to receive and/or couple to one of the one or more tabs 452 such the inner post 402 is coupled to the outer post 404. The coupling of the inner post 402 to the outer post 404 by the one or more tabs 452 and the one or more slots 456 substantially aligns the inner post 402 such that the first post passage 418 defined by the inner post 402 substantially ends at the first set of windows 460 and an outer surface of the inner post 402 fluidly separates the first post passage 418 and the second post passage 420.

The axial center post 400 includes one or more sealing members 470 for forming a radial seal between the axial center post 400 and the filter housing body 104.

The inner post 402 also includes one or more axial flanges 464 that are structured to facilitate coupling the inner post 402 to the outer post 404 at the first post end 430.

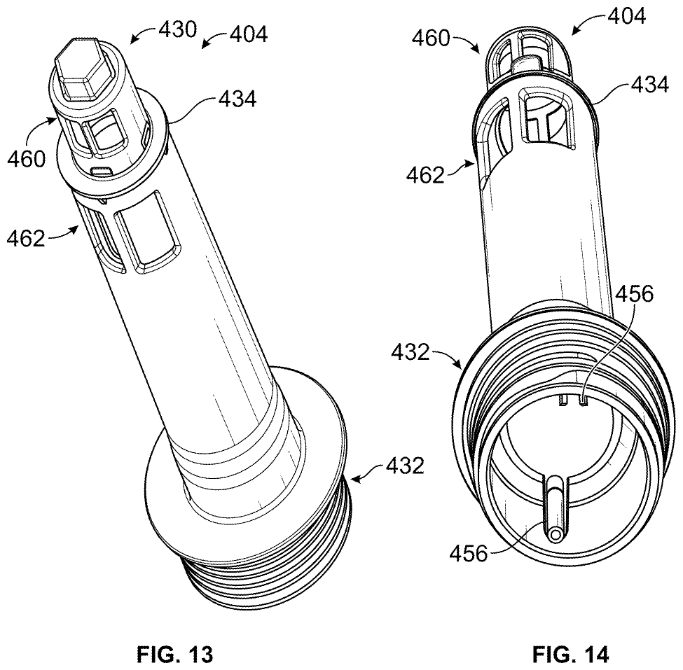

FIG. 13 is a top perspective view of the outer post 404 of the axial center post 400 of FIG. 12. The first set of windows 460 is show to be at the first post end 430. The second set of windows 460 is between the first set of windows 460 and the second post end 432. The post shoulder 434 is positioned between the first set of windows 460 and the second set of windows 462 such that the first set of windows are radially inward form the second set of windows 462.

FIG. 14 is a bottom perspective view of the outer post 404 of the axial center post 400 of FIG. 12. The one or more slots 456 are shown on an inner surface of the outer post 404 and proximal the second post end 432. In the embodiment shown, the outer post 404 includes two slots 456. In other embodiments, the outer post 404 may include more or fewer slots 456.

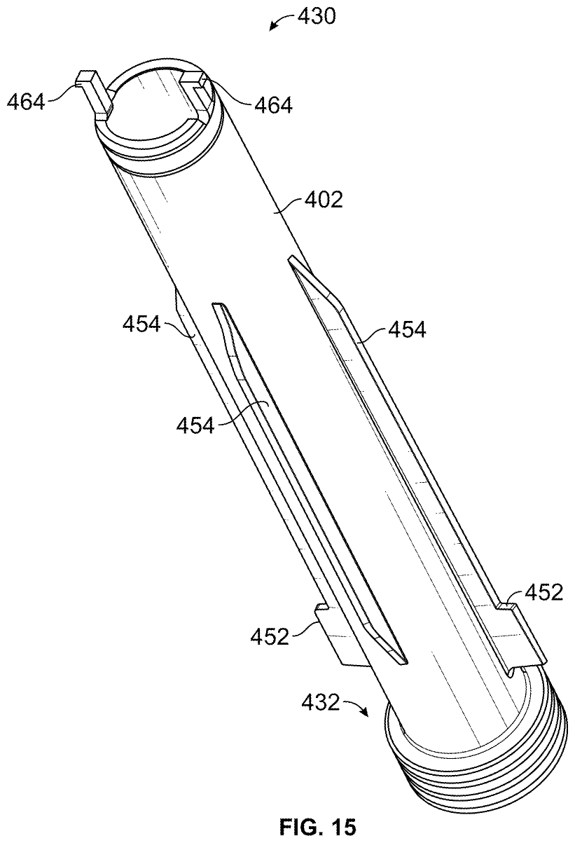

FIG. 15 is a perspective view of the inner post 402 of the axial center post 400 of FIG. 12. The one or more tabs 452 are shown to extend radially outward from the inner post 402. The inner post 402 is shown to include two tabs 452. In other embodiments, the inner post 402 may include more or fewer tabs 452. The ribs 454 are shown to extend radially outward from the inner post 402. The inner post 402 is shown to include four ribs 454 (one hidden from view). In other embodiments, the inner post 402 may include more or fewer ribs 454. One or more of the ribs 454 is formed with the one or more of the tabs 452 such that the rib 454 and the tab 452 form a continuous and unitary structure. The one or more axial flanges 464 are shown to extend axially way from the inner post 402 towards the first post end 430.

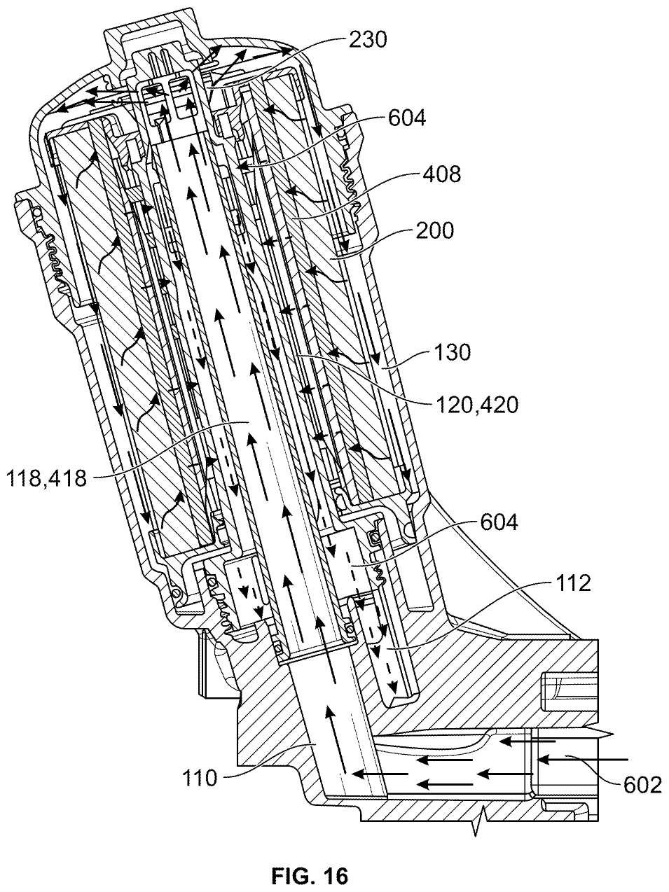

Referring generally to FIGS. 16-18, various views of the fluid filtration system 100 and/or engine interface 500 showing various fluid flow paths are shown. Although FIGS. 16-18 may show components related to a particular embodiment described herein, it should be understood that the flow paths shown may be used in any of the embodiments described herein.

FIG. 16 is a cross-sectional view of the fluid filtration system 100 of FIG. 10, showing a fluid flow path. An inlet flow path 602 is shown to enter the fluid filtration system 100 at the first passage 110. The inlet flow path 602 continues through the first post passage 118, 418. The inlet flow path 602 then flows out of the axial center post 106, 400, and into the hollow cavity 130. The inlet flow path 602 the flows into the filter element 408 and through the media pack 200. The filtered fluid flows along an outlet flow path 604 out of the media pack 200 and into the axial center post 106, 400. The outlet flow path 604 exits the fluid filtration system 100 via the second passage 112.

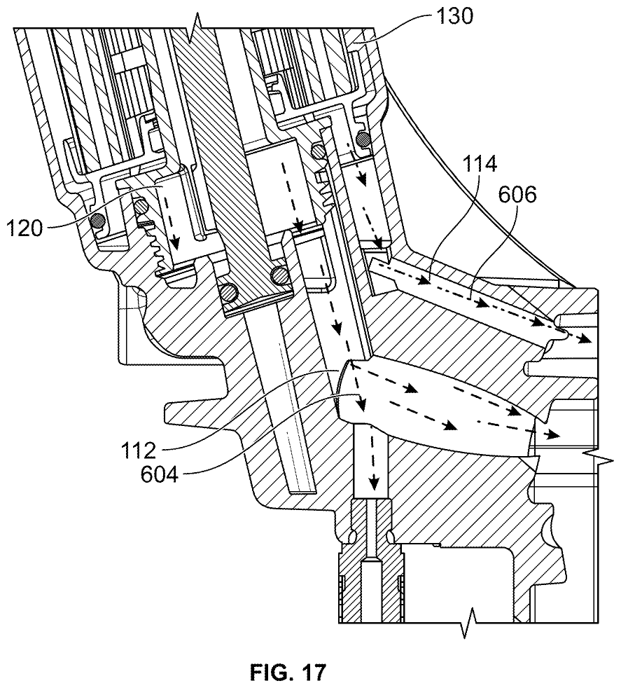

FIG. 17 is a detailed cross-sectional view of the fluid filtration system 100 of FIG. 10, showing a fluid flow path. The outlet flow path 604 is shown to flow out of the fluid filtration system 100 via the second passage 112 and to one or more downstream components (e.g., the engine interface 500. A drain flow path 606 is shown to flow from the hollow cavity 130 and through the third passage 114. The third passage 114 drains the fluid to a downstream component or reservoir.

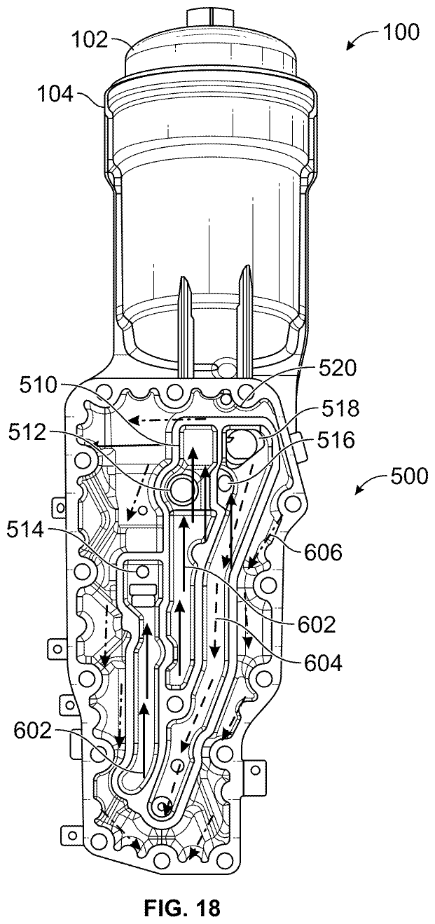

FIG. 18 is a rear view of the fluid filtration system and engine interface 500 of FIG. 9, showing a fluid flow path. The inlet flow path 602 is shown to flow through the pressure regulator valve 514 and into the inlet port 510. The inlet flow path 602 continues to the first passage 110, as described above. The outlet flow path 604 flows from the second passage 112 and out the outlet port 518. The outlet flow path 604 flows through the engine interface 500 and to a downstream component, such as an engine. The outlet flow path 604 may also flow through the turbo fitting 502. The drain flow path 606 flows from the third passage 114 and through the drain port 520. The drain flow path 606 flows through the engine interface 500 and to a downstream component or reservoir.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “approximately,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language a “portion” is used, the item can include a portion and/or the entire item unless specifically stated to the contrary.

What is claimed is:

1. A fluid filtration system comprising:
a filter housing body having a first housing end and a second housing end opposite the first housing end;
a first passage extending from the second housing end;
a second passage extending from the second housing end; and
a center post coupled to the filter housing body and extending along a central axis of the filter housing body, the center post in fluid communication with the first passage and the second passage.

2. The fluid filtration system of claim 1, wherein the center post is coupled to the second housing end and extends out of the first housing end.

3. The fluid filtration system of claim 1, wherein the center post includes a first post passage in fluid communication with the first passage and a second post passage in fluid communication with the second passage.

4. The fluid filtration system of claim 3, wherein the second post passage is concentric about the first post passage.

5. The fluid filtration system of claim 3, further comprising:
a first post sealing member coupled to the center post and configured to fluidly isolated the first passage and the second passage; and
a second post sealing member coupled to the center post and configured to fluidly isolate a housing cavity of the filter housing body from the second passage.

6. The fluid filtration system of claim 1, wherein the center post further comprises:
a first post end and a second post end opposite the first post end, the second post end coupled to the filter housing body; and
a first post aperture positioned at the first post end and structured to allow fluid communication between the first passage and a housing cavity of the filter housing body.

7. The fluid filtration system of claim 6, further comprising a second post aperture extending through the center post at a position between the first post end and the second post end, the second post aperture structured to allow fluid communication between the housing cavity and the center post.

8. The fluid filtration system of claim 7, further comprising a post shoulder extending radially from the center post at a position between the first post aperture and the second post aperture.

9. The fluid filtration system of claim 1, wherein the center post further comprises a post shoulder extending radially away from the center post proximate to an end of the center post opposite the second housing end, the post shoulder having a substantially circular sealing surface configured to provide an axial sealing engagement with a sealing member of a filter element.

10. The fluid filtration system of claim 1, further comprising a third passage extending from the second housing end, the third passage configured to receive a flow of fluid from a housing cavity of the filter housing body and provide the flow of fluid to a reservoir upstream of one of the first passage and the second passage.

11. A fluid filtration system comprising:
a filter housing body coupled to an engine interface, the engine interface including a first passage and a second passage, both the first passage and the second passage extending away from the filter housing body;
a center post coupled to the filter housing body and extending along a central axis of the filter housing body, the center post in fluid communication with both the first passage and the second passage;
a filter housing lid removably coupled to the filter housing body; and
a filter element configured for positioning within the filter housing body.

12. The fluid filtration system of claim 11, wherein the center post includes a post shoulder extending radially away from the center post, the post shoulder comprising an axial sealing surface configured to form a sealing engagement with the filter element.

13. The fluid filtration system of claim 12, further comprising:
an element sealing member configured to form a sealing engagement with the axial sealing surface of the post shoulder; and
a biasing member coupled to the filter housing lid and configured to provide an axial force to the filter element to compress the element sealing member when the filter element is positioned within the filter housing body and the filter housing lid is coupled to the filter housing body.

14. The fluid filtration system of claim 12, wherein:
the center post includes a first post end and a second post end opposite the first post end, the second post end coupled to the filter housing body;
the center post extends outside of the filter housing body and beyond a first end of the filter housing body; and
the post shoulder is positioned between the first post end and the first end of the filter housing body.

15. The fluid filtration system of claim 14, wherein the engine interface further comprises a third passage in fluid communication with a housing cavity of the filter housing body, the third passage leading to a reservoir upstream of the first passage.

16. A filter element comprising:
a media pack defining a hollow cavity;
a first endplate coupled to the media pack, the first endplate comprising:
a first endplate surface;
a first inner flange extending axially away from the first endplate surface into the hollow cavity of the media pack;
a second inner flange defining an L-shaped cross-section and extending radially inward from the first inner flange; and
a first axial sealing member positioned within a groove defined by the first inner flange and the second inner flange, the first axial sealing member configured to compress against an axial center post to form a first sealing engagement;
a second endplate coupled to the media pack opposite to the first endplate, the second endplate comprising:
a second endplate surface;
a third inner flange extending axially away from the second endplate surface and toward the first endplate; and
a first radial sealing member contacting the third inner flange.

17. The filter element of claim 16, wherein the second inner flange includes a second flange surface positioned between the first endplate surface and the second endplate surface, the second flange surface cooperating with an inner surface of the first inner flange to define a biasing groove configured to receive a portion of a biasing member.

18. The filter element of claim 16, wherein a first diameter of the first endplate is less than a second diameter of the second endplate.

19. The filter element of claim 16, wherein the second endplate further comprises:
an outer flange extending axially away from the second endplate surface; and
a second radial sealing member contacting the outer flange.

20. The filter element of claim 16, wherein the first axial sealing member is positioned entirely within the hollow cavity of the media pack.
